(19) United States
(12) Patent Application Publication
(10) Pub. No.: US 2020/0160254 A1
(43) Pub. Date: May 21, 2020

(54) Group Assignments

(71) Applicant: SAP SE, Walldorf (DE)

(72) Inventors: Anshika Goyal, Madhya Pradesh (IN); Nisha V. Nair, Bangalore (IN); Dileep Suresh, Bangalore (IN); Karthik Lakshminarasimha Simha, Bangalore (IN); Shashank S. Chetty, Bangalore (IN); Tejas A. V, Bangalore (IN)

(21) Appl. No.: 16/195,539

(22) Filed: Nov. 19, 2018

(51) Int. Cl. G06Q 10/06

(52) U.S. Cl. CPC G06Q 10/063116; G06Q 10/06316

(57) ABSTRACT

A user interface is presented that allows a user to group tasks. After the tasks are grouped, reassigning one of the assignments from a first resource to a second resource causes one or more subsequent assignments to also be reassigned. In some example embodiments, the reassignment changes the duration of the reassigned tasks. For example, a first resource may be unavailable on Tuesday and assigned tasks on Monday and Wednesday. Reassigning the two tasks to a different resource that is available on Tuesday may cause the tasks to be assigned on Monday and Tuesday, thus taking two calendar days to complete instead of three. Deleting one of the assignments causes one or more subsequent assignments to also be deleted.

### TECHNICAL FIELD

The subject matter disclosed herein generally relates to assigning tasks to resources. Specifically, the present disclosure addresses systems and methods to group tasks for more efficient assigning of resources to perform the tasks in the group.

### BACKGROUND

A task scheduling system allows tasks to be assigned to resources to be performed at specified times. Lengthy tasks may be automatically split into multiple smaller tasks, one per day, when assigned to a resource. Each of the smaller tasks can be individually reassigned from one resource to another.

### BRIEF DESCRIPTION OF THE DRAWINGS

Some embodiments are illustrated by way of example and not limitation in the figures of the accompanying drawings.

FIG. 1 is a network diagram illustrating a network environment suitable for group assignments, according to some example embodiments.

FIG. 2 is a block diagram of an application server, according to some example embodiments, suitable for group assignments.

FIG. 3 is a block diagram illustrating a database schema suitable for group assignments, according to some example embodiments.

FIG. 4 is a flowchart illustrating operations of a method suitable for reassigning tasks using group assignments, according to some example embodiments.

FIG. 5 is a flowchart illustrating operations of a method suitable for reassigning tasks using group assignments, according to some example embodiments.

FIG. 6 is a user interface diagram of a user interface suitable for creating group assignments, according to some example embodiments.

FIG. 7 is a user interface diagram of a user interface suitable for presenting and modifying group assignments, according to some example embodiments.

FIG. 8 is a user interface diagram of a user interface suitable for presenting and modifying group assignments, according to some example embodiments.

FIG. 9 is a user interface diagram of a user interface suitable for presenting and modifying group assignments, according to some example embodiments.

FIG. 10 is a user interface diagram of a user interface suitable for presenting and modifying group assignments, according to some example embodiments.

FIG. 11 is a user interface diagram of a user interface suitable for presenting and modifying group assignments, according to some example embodiments.

FIG. 12 is a user interface diagram of a user interface suitable for presenting and modifying group assignments, according to some example embodiments.

FIG. 13 is a user interface diagram of a user interface suitable for grouping assignments, according to some example embodiments.

FIG. 14 is a block diagram illustrating components of a machine, according to some example embodiments.

### DETAILED DESCRIPTION

Example methods and systems are directed to the grouping of assignments and manipulating group tasks. A user interface may be presented that allows a user to group tasks. After the tasks are grouped, reassigning one of the assignments from a first resource to a second resource causes one or more subsequent assignments to also be reassigned. The first and second resource may be personnel resources (e.g., engineers or technicians), computing resources (e.g., central processing units (CPUs) or memory storage components), or other resources.

In some example embodiments, the reassignment changes the duration of the reassigned tasks. For example, a first resource may be unavailable on Tuesday and assigned tasks on Monday and Wednesday. Reassigning the two tasks to a different resource that is available on Tuesday may cause the tasks to be assigned on Monday and Tuesday, thus taking two calendar days to complete instead of three.

By comparison with prior art methods in which tasks are reassigned individually, operator time is saved along with corresponding computing resources (e.g., CPU cycles, computer power consumption, and memory). As the number of tasks reassigned as a group increases, the savings over existing single-reassignment methods increases. Accordingly, one or more of the methodologies described herein may obviate a need for certain efforts or resources that otherwise would be involved in changing assignments. Computing resources used by one or more machines, databases, or networks may similarly be reduced. Examples of such computing resources include processor cycles, network traffic, memory usage, data storage capacity, power consumption, and cooling capacity.

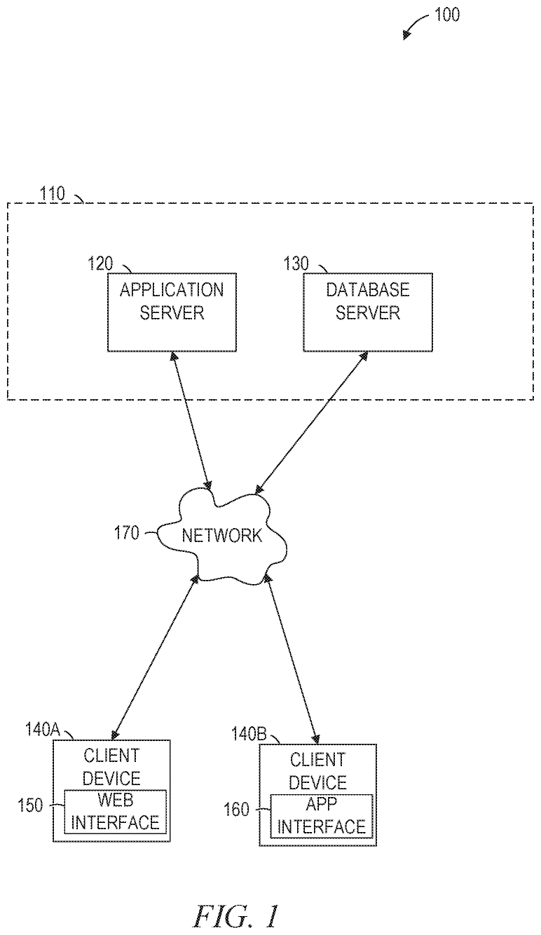

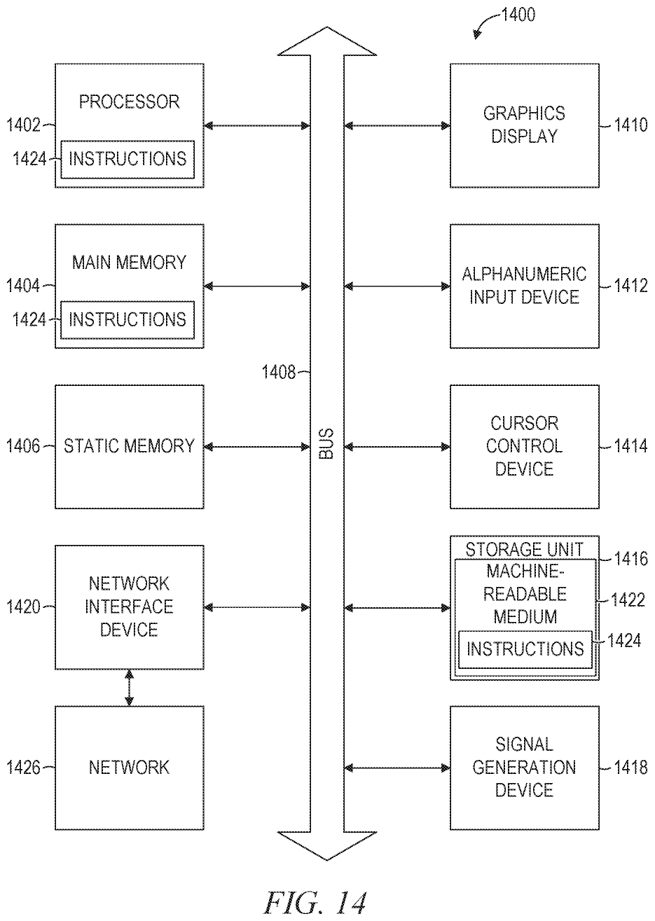

FIG. 1 is a network diagram illustrating a network environment 100 suitable for group assignments, according to some example embodiments. The network environment 100 includes a network-based application 110, client devices 140A and 140B, and a network 170. The network-based application 110 is provided by an application server 120 in communication with a database server 130. The application server 120 provides an application to the client devices 140A and 140B via a web interface 150 or an application interface 160. The application server 120, the database server 130, and the client devices 140A and 140B may each be implemented in a computer system, in whole or in part, as described below with respect to FIG. 14. The client devices 140A and 140B may be referred to collectively as client devices 140 or generically as a client device 140.

The application server 120 provides an application to the client devices 140. The application includes an ability to assign tasks to resources, to group tasks, to reassign grouped tasks, to delete grouped tasks, or any suitable combination thereof.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 14. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 120, database server 130, and the client devices 140A-140B may be connected by the network 170. The network 170 may be any network that enables communication between or among machines, databases, and devices. Accordingly, the network 170 may be a wired network, a wireless network (e.g., a mobile or cellular network), or any suitable combination thereof. The network 170 may include one or more portions that constitute a private network, a public network (e.g., the Internet), or any suitable combination thereof.

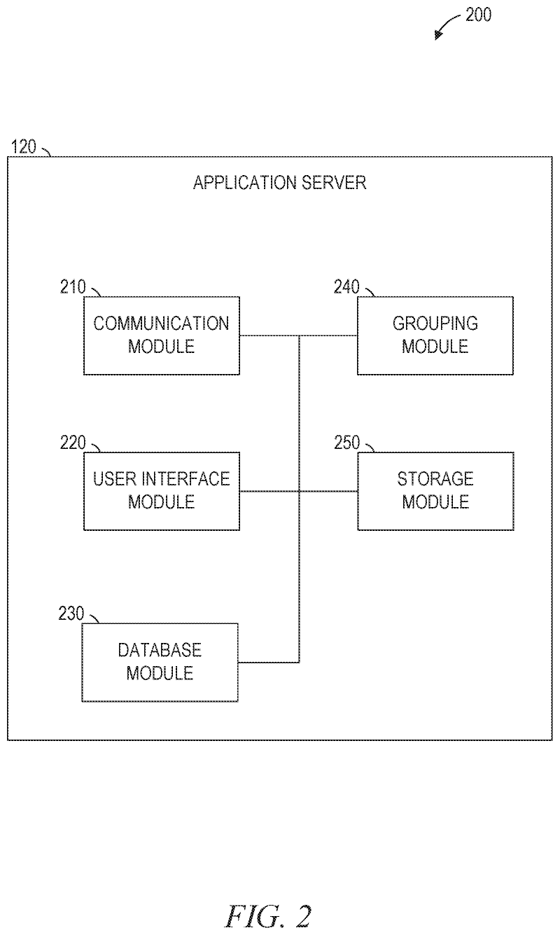

FIG. 2 is a block diagram 200 illustrating components of the application server 120, according to some example embodiments. The application server 120 is shown as including a communication module 210, a user interface module 220, a database module 230, a grouping module 240, and a storage module 250, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 receives data sent to the application server 120 and transmits data from the application server 120. For example, the communication module 210 may receive, from the client device 140A, a request for data regarding tasks assigned to one or more resources. The communication module 210 provides the query to the database module 230. The database module 230 searches a database via the storage module 250 to identify records responsive to the query. The communication module 210 may transmit the responsive data to the client device 140A, provide the responsive data to the user interface module 220 for further processing, or any suitable combination thereof. Communications sent and received by the communication module 210 may be intermediated by the network 170.

The user interface module 220 causes presentation of a user interface for the application server 120 on a display associated with the client device 140A or 140B. The user interface allows a user to view existing task assignments, modify task assignments, create task assignments, delete task assignments, or any suitable combination thereof.

The grouping module 240 groups tasks and handles assignments of grouped tasks. Accordingly, the grouping module 240 enables a user of the device 140A or 140B to reassign multiple tasks with a single command.

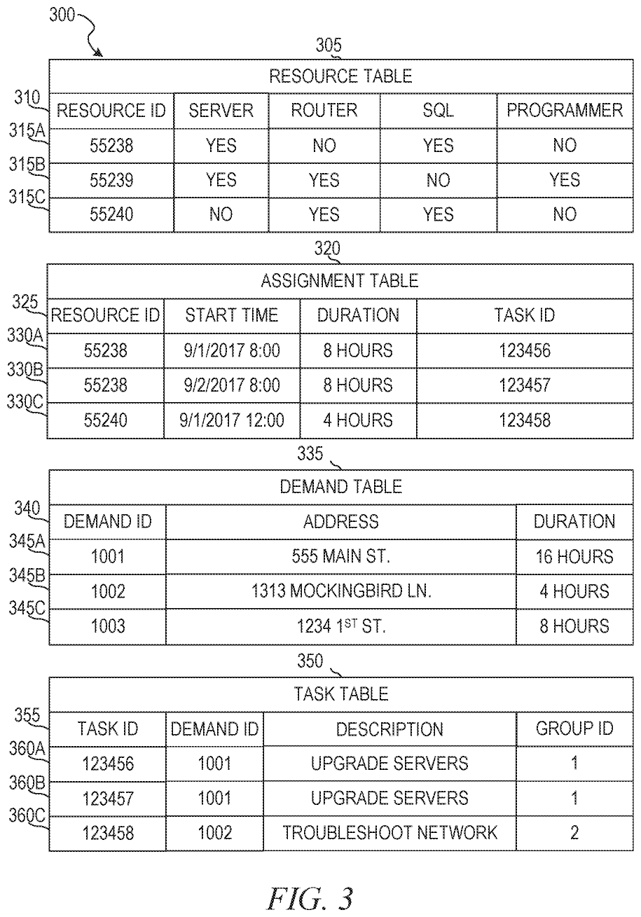

FIG. 3 is a block diagram illustrating a database schema 300 suitable for implementing group assignments, according to some example embodiments. The database schema 300 includes a resource table 305, an assignment table 320, a demand table 335, and a task table 350. The resource table 305 has rows 315A, 315B, and 315C of a format 310. Each row of the resource table 305 stores data for a resource to which tasks can be assigned. The assignment table 320 has rows 330A, 330B, and 330C of a format 325. Each row of the assignment table 320 stores data for an assignment of a task to a resource. The demand table 335 has rows 345A, 345B, and 345C of a format 340. Each row of the demand table 335 stores data for a demand. A demand is a set of one or more tasks to be performed at a location. The task table 350 has rows 360A, 360B, and 360C of a format 355. Each row of the task table 350 stores data for a task.

The format 310 of the resource table 305 includes a resource identifier field, a server field, a router field, a software query language (SQL) field, and a programmer field. The resource identifier field stores a unique identifier for the resource of each row. The remaining fields store data regarding the capabilities of the resource. Thus, the row 315A stores data for the resource with identifier 55238 and the identified resource has server and SQL capabilities but not router or programmer capabilities.

The format 325 of the assignment table 320 includes a resource identifier field, a start time field, a duration field, and a task identifier field. The resource identifier field relates a row in the assignment table 320 to a row in the resource table 305 and identifies the resource to which a task is assigned. The start time field stores a time at which the assigned task is to begin. The duration field stores a duration for the assignment. The task identifier relates to a row in the task table 350 and identifies the assigned task. In some example embodiments, the assignment table 320 also stores a status indicator for each row. For example, the status indicator may indicate that the assignment has not yet begun, that the assignment is in progress, that the assignment is completed, that the assignment is cancelled, or any suitable combination thereof.

The format 340 of the demand table 335 includes a demand identifier field, an address field, and a duration field. The demand identifier field stores an identifier for the demand. The address field stores an address for the demand. The duration field stores the total duration for the demand. When a demand is converted to one or more tasks, the total duration of the tasks is equal to the duration of the demand.

Each of the rows 360A-360C stores data in the format 355 of the task table 350 comprising a task identifier field, a demand identifier field, a description field, and a group identifier field. The task identifier is a unique identifier of the task. The demand identifier stores an identifier of the demand from which the task was generated. The description is a human-readable description of the task to be performed. The group identifier stores an identifier of a group of assignments to which the assignment belongs. Rows 360A and 360B have the same group identifiers and thus are in the same group. Row 360C has a different group identifier and thus is in a different group.

In some example embodiments, the format 325 of the assignment table 320 or the format 355 of the task table 350 includes capabilities required to perform the assignment or the task. For example, a SQL field in the rows 360A-360C may indicate whether the task requires SQL capabilities. By cross-referencing the SQL field of the task being assigned to the SQL field of the available resources, assigning a task to a resource incapable of performing the task can be prevented.

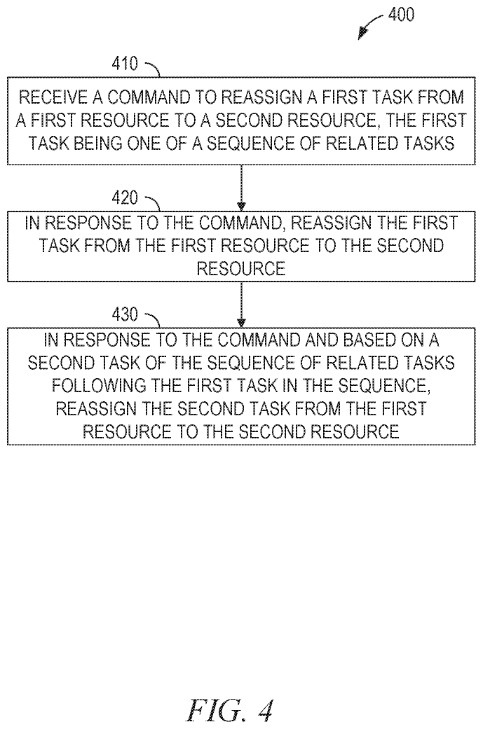

FIG. 4 is a flowchart illustrating operations of a method 400 suitable for reassigning tasks using group assignments, according to some example embodiments. The method 400 includes operations 410, 420, and 430. By way of example and not limitation, the method 400 is described as being performed by the devices, modules, and databases of FIGS. 1-3.

The grouping module 240 receives, in operation 410, a command to reassign a first task from a first resource to a second resource, the first task being one of a sequence of related tasks. For example, with reference to the assignment table 320 of FIG. 3, a command to reassign the task 123456 from the resource 55238 to the resource 55240 may be received. The task table 350 of FIG. 3 shows that the task 123456 is related to the task 123457 by virtue of the shared group identifier in the rows 360A and 360B. The assignment table 320 shows that the start time of the assignment of the task 123456 is before the start time of the task 123457, providing an order to the assignments and allowing the unordered group of tasks (as stored in the task table 350) to be treated as a sequence of related tasks.

In operation 420, the grouping module 240, in response to the command, reassigns the first task from the first resource to the second resource. For example, the resource identifier of the row 330A may be updated to have the value 55240 instead of 55238.

In operation 430, the grouping module 240, in response to the command and based on a second task of the sequence of related tasks following the first task in the sequence, reassigns the second task from the first resource to the second resource. For example, based on the task 123457 following the task 123456 and in response to the command, the resource identifier of the row 330B may be updated to have the value 55240 instead of 55238.

Thus, after execution of the method 400, both the first task and the second task are reassigned from the first resource to the second resource, even though the received command was to reassign the first task without including an indication of the second task. By comparison with prior art methods in which tasks are reassigned individually, operator time is saved along with corresponding computing resources (e.g., CPU cycles, computer power consumption, and memory).

In some example embodiments, the sequence of related tasks comprises three related tasks, four related tasks, or a larger number of related tasks. In these example embodiments, operation 430 may be repeated for each additional related task beyond the second, causing all of the related tasks to be reassigned in response to the single command received in operation 410. Using prior art methods in which tasks are reassigned individually, the effort (by both the operator and the computer) to reassign the tasks increases linearly with the number of tasks reassigned. By contrast, using the method described above, only a single command is received that causes reassignment of all related tasks, reducing network communication of the commands. The user interface may be updated once, after all reassignments are complete, instead of after each independent reassignment, reducing network communication of user interface data, CPU or graphical processing unit (GPU) cycles, power consumption, or any suitable combination thereof.

The method 400 is described as performing a reassignment operation on related tasks in response to a command performed on one task, but the method 400 can be used to perform other operations on the related tasks. For example, if the command received in operation 410 is a command for deleting a task instead of reassigning the task, operation 420 can be replaced with an operation for deleting the task and operation 430 can be replaced with an operation for deleting the second task of the sequence of related tasks. In this way, a group of related tasks are deleted in response to a command to delete a single task. The modified operation 430 may be repeated for all subsequent related tasks.

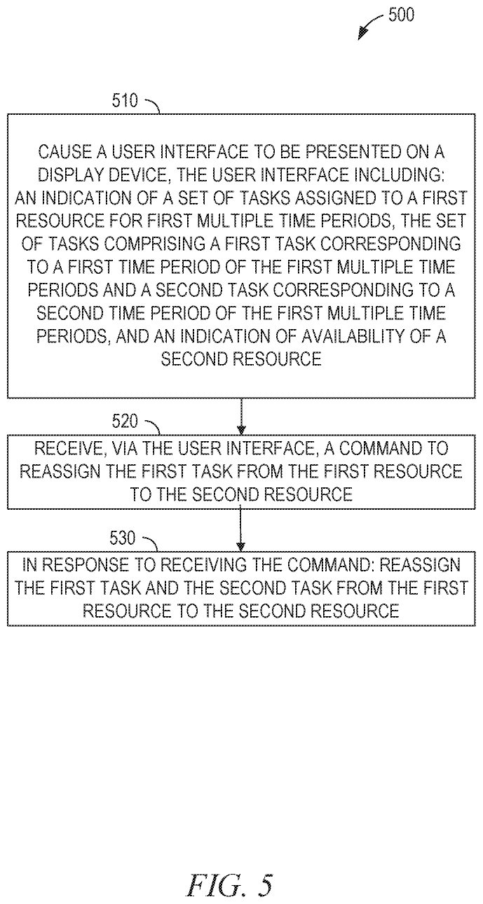

FIG. 5 is a flowchart illustrating operations of a method 500 suitable for reassigning tasks using group assignments, according to some example embodiments. The method 500 includes operations 510, 520, and 530. By way of example and not limitation, the method 500 is described as being performed by the devices, modules, and databases of FIGS. 1-3.

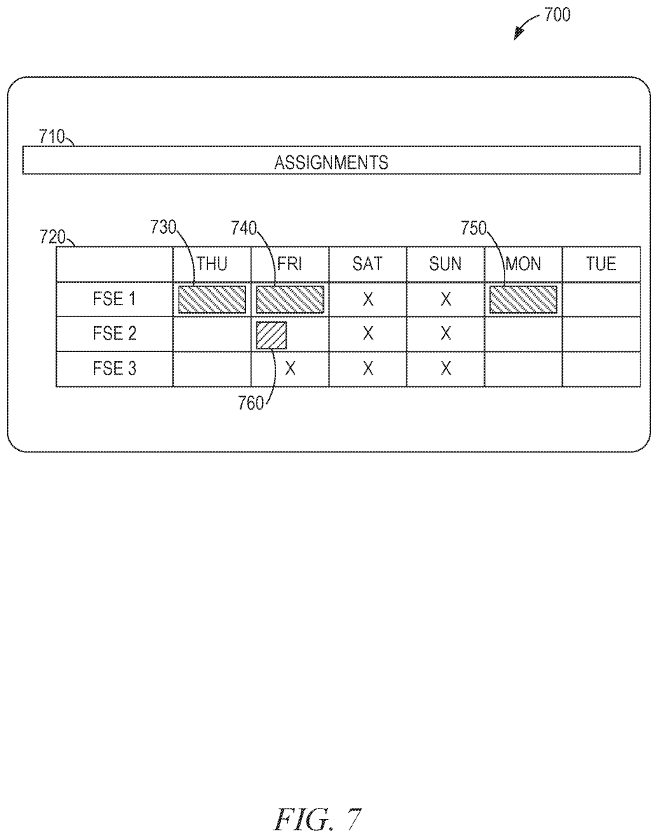

In operation 510, the user interface module 220 causes a user interface to be presented on a display device (e.g., a screen of the client device 140A). The user interface includes an indication of a set of tasks assigned to a first resource for first multiple time periods and an indication of availability of a second resource. The set of tasks comprises a first task corresponding to a first time period of the first multiple time periods and a second task corresponding to a second time period of the first multiple time periods. For example, the user interface 700 (FIG. 7) may be presented, including assignment indicators 740 and 750 corresponding to tasks assigned on Friday and Monday for a first resource labeled “FSE 1.” The user interface 700 also shows an indication of availability for a second resource labeled “FSE 2.”

In operation 520, the group assignment module 240 receives, via the user interface (and the user interface module 220), a command to reassign the first task from the first resource to the second resource. For example, the user may click on the assignment indicator 740 and drag it to the position of Friday for the second resource. In response, the web browser (implementing the web interface 150) or application (implementing the application interface 160) may send a command to the application server 120 via the network 170, the command including an indication of the first task (e.g., a task identifier from the task table 350), an indication of the second resource (e.g., a resource identifier from the resource table 305), and an indication of the time and date of the new assignment (e.g., a timestamp corresponding to “Friday”).

In operation 530, the group assignment module 240, in response to receiving the command, reassigns both the first task and the second task from the first resource to the second resource. For example, database entries for both tasks may be updated to reflect the reassignment, even though the received command only indicated the first task. As discussed above with respect to FIG. 4, the second task can be identified based on the first task, a group identifier of the first task that is the same as a group identifier of the second task, and a sequential relationship between the assignment of the first task to the first resource and the assignment of the second task to the first resource.

In some example embodiments, the format 325 of the assignment table 320 or the format 355 of the task table 350 includes capabilities required to perform the assignment or the task. In these example embodiments, the group assignment module 240 may determine if the resource to which the group assignment is being reassigned possesses the capabilities required. If the resource does possess the capabilities, the reassignment is allowed as described above. If the resource is lacking one or more of the capabilities required by the task, the group assignment module 240 instead does not reassign either the first task or the second task. In addition to or instead of preventing the reassignment, the group assignment module 240 may cause an error message to be displayed that indicates which capabilities are required by the task and are lacked by the requested new assignee.

In some example embodiments, the assignment table 320 stores a status indicator for each row. In these example embodiments, the group assignment module 240 may determine if any of the assignments requested to be moved have a status indicator that indicates that the assignment is in progress or has been cancelled. Based on the assignment status indicator, the group assignment module 240 opts not to reassign either the first task or the second task. The group assignment module 240 may cause an error message to be displayed that indicates which assignments are already in progress or have been canceled.

The group assignment module 240 may also support deletion of group assignments. Based on the assignment status indicator, the group assignment module 240 opts not to delete either the first task or the second task. The group assignment module 240 may cause an error message to be displayed that indicates which assignments are already in progress or have been canceled.

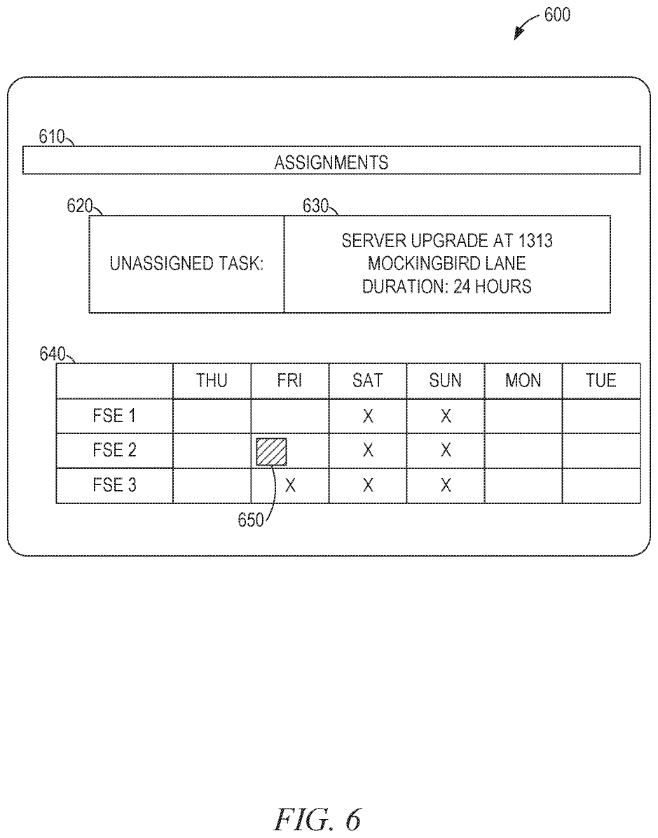

FIG. 6 is a user interface diagram of a user interface 600 suitable for creating group assignments, according to some example embodiments. The user interface 600 includes a title 610, a header 620, a task description 630, an assignment calendar 640, and an assignment indicator 650.

The title 610 indicates that the user interface 600 is displaying assignments. The header 620 indicates that the task description 630 describes an unassigned task. The task description 630 describes an available task by providing the task to be performed (a server upgrade), the demand for the task (1313 Mockingbird Lane), and a total duration for the task (24 hours). The assignment calendar 640 shows availability and assignments for three resources (field support engineer (“FSE”) 1, FSE 2, and FSE 3) for six days (Thursday-Tuesday). FSE 1 and FSE 2 are each available on Thursday, Friday, Monday, and Tuesday, as indicated by the presence of blank space or the assignment indicator 650 for those resource/day combinations. FSE 3 is available on Thursday, Monday, and Tuesday. Each of the three resources is unavailable on Saturday and Sunday, as indicated by the presence of an X for those resource/day combinations. FSE 3 is unavailable on Friday, as indicated by an additional X in the corresponding area.

The user interface may receive a user input indicating that the unassigned task should be assigned to one of the resources beginning on a particular day. For example, the task description 630 may be dragged to the area for FSE 1 on Thursday. Based on the selection of the resource, the selection of the start date, the availability of the FSE 1 resource, a standard workday of 8 hours, and the total duration of the unassigned task, the task may be divided into three tasks of 8 hours duration each and the three tasks may be assigned to FSE 1 on Thursday, Friday, and Monday. If the task description 630 were dragged into the area for FSE 3 on Thursday, the three tasks of 8 hours duration each would be assigned to FSE 3 on Thursday, Friday, and Tuesday, due to the different availability of the different resource.

FIG. 7 is a user interface diagram of a user interface 700 suitable for presenting and modifying group assignments, according to some example embodiments. The user interface 700 includes a title 710, an assignment calendar 720, and assignment indicators 730, 740, 750, and 760. The user interface 700 may be presented after the task corresponding to the task description 630 is assigned to the resource FSE 1.

The title 710 indicates that the user interface 700 is displaying assignments. The assignment calendar 720 shows availability and assignments for three resources (FSE 1, FSE 2, and FSE 3) for six days (Thursday-Tuesday). FSE 1 and FSE 2 are each available on Thursday, Friday, Monday, and Tuesday, as indicated by the presence of blank space or one of the assignment indicators 730-760 for those resource/day combinations. FSE 3 is available on Thursday, Monday, and Tuesday. Each of the three resources is unavailable on Saturday and Sunday, as indicated by the presence of an X for those resource/day combinations. FSE 3 is also unavailable on Friday.

Assignment indicators for related tasks may have one or more graphical attributes in common to indicate that the tasks are related. The graphical attribute may be unique among the assignment indictors so that the related tasks are quickly distinguishable from other tasks. In FIG. 7, the assignment indicators 730, 740, and 750 have the same fill pattern while the assignment indicator 760 has a unique fill pattern. Thus, at a glance, a user can determine that the tasks for the assignments indicated by the assignment indicators 730-750 are related to each other and that the task for the assignment indicated by the assignment indicator 760 is not related to the task for any other displayed assignment indicator. Additionally, positioning of the assignment indicators 730-760 within the calendar 720 indicates at a glance that tasks corresponding to the assignment indicators are assigned to FSE 1 on Thursday, Friday, and Monday and that a task is assigned to FSE 2 on Friday. The smaller size of the assignment indicator 760 relative to the size of the other assignment indicators may indicate that the task corresponding to the assignment indicator 760 is of shorter duration than the other tasks. The positioning of each assignment indicator within its calendar area may indicate the time that the corresponding task is to be performed. For example, the tasks corresponding to the assignment indicators 730-750 may be full-day tasks, as indicated by each of the assignment indicators 730-750 occupying nearly all of each of their calendar areas. By contrast, the task corresponding to the assignment indicator 760 may be scheduled for the first half of Friday, as indicated by the position and size of the assignment indicator 760.

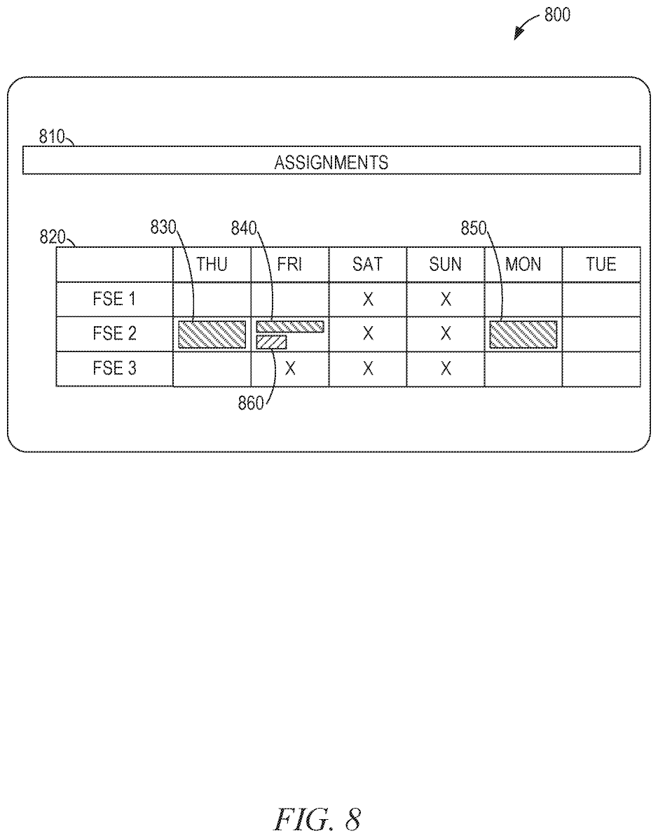

FIG. 8 is a user interface diagram of a user interface 800 suitable for presenting and modifying group assignments, according to some example embodiments. The user interface 800 includes a title 810, an assignment calendar 820, and assignment indicators 830, 840, 850, and 860. The user interface 800 may be displayed after a user input is received via the user interface 700, the user input indicating that the task assigned to FSE 1 on Thursday should be reassigned to FSE 2 on the same date. For example, the user may have selected the assignment indicator 730 and then selected empty space within the region of the calendar 720 for FSE 2 on Thursday. As another example, the user may have dragged the assignment indicator 730 into the region of the calendar 720 for FSE 2 on Thursday.

The title 810 indicates that the user interface 800 is displaying assignments. The assignment calendar 820 shows availability and assignments for three resources (FSE 1, FSE 2, and FSE 3) for six days (Thursday-Tuesday).

The assignment indicators 830, 840, 850, and 860 correspond to the assignment indicators 730, 740, 750, and 760 of FIG. 7. The tasks corresponding to the assignment indicators 730-750 have been reassigned from FSE 1 to FSE 2 and are now shown as the assignment indicators 830-850. The assignment indicator 860 has been reduced in size to allow the assignment indicator 840 to also be presented in the area for Friday for FSE 2. Furthermore, the assignment calendar 820 has been updated to show that the tasks corresponding to the assignment indicators 830-850 are no longer assigned to the resource FSE 1.

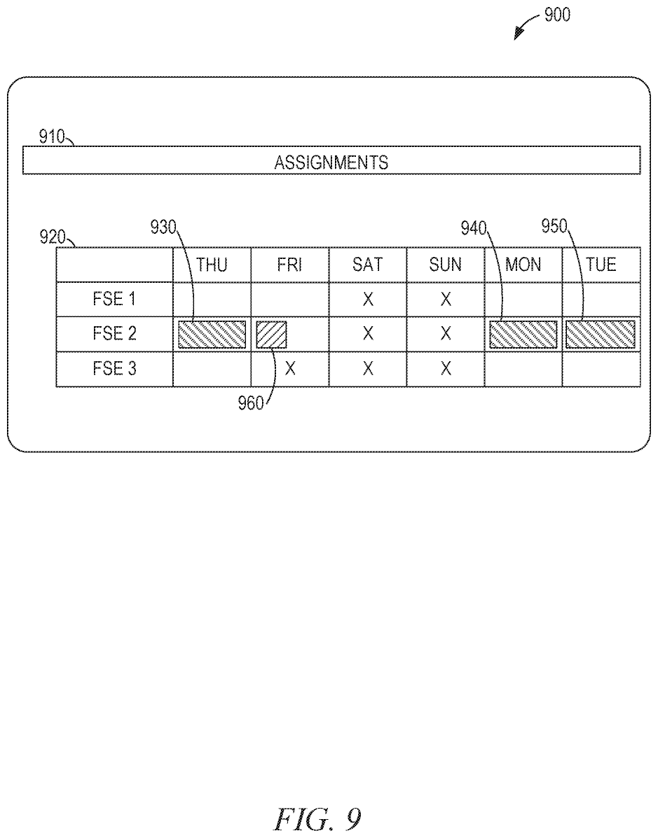

FIG. 9 is a user interface diagram of a user interface 900 suitable for presenting and modifying group assignments, according to some example embodiments. The user interface 900 includes a title 910, an assignment calendar 920, and assignment indicators 930, 940, 950, and 960. The user interface 900 may be displayed after a user input is received via the user interface 700, the user input indicating that the task assigned to FSE 1 on Thursday should be reassigned to FSE 2 on the same date. For example, the user may have selected the assignment indicator 730 and then selected empty space within the region of the calendar 720 for FSE 2 on Thursday. As another example, the user may have dragged the assignment indicator 730 into the region of the calendar 720 for FSE 2 on Thursday.

The title 910 indicates that the user interface 900 is displaying assignments. The assignment calendar 920 shows availability and assignments for three resources (FSE 1, FSE 2, and FSE 3) for six days (Thursday-Tuesday).

The assignment indicators 930, 940, 950, and 960 correspond to the assignment indicators 730, 740, 750, and 760 of FIG. 7. The tasks corresponding to the assignment indicators 730-750 have been reassigned from FSE 1 to FSE 2 and are now shown as the assignment indicators 930-950. In the example embodiment of FIG. 9, unlike the example embodiment of FIG. 8, the task assigned to FSE 2 for the first half of Friday causes FSE 2 to be treated as unavailable during that time for receiving new assignments. As a result, the tasks corresponding to the assignment indicators 740 and 750 are scheduled for the next available days for FSE 2: Monday and Tuesday. Thus, the tasks corresponding to the assignment indicators 930 and 940 have been assigned to FSE 2 for multiple time periods (Thursday and Monday) and the multiple time periods are distinct from the time periods of the assignments of the same two tasks to FSE 1 (Thursday and Friday, as indicated by the assignment indicators 730 and 740 of FIG. 7).

Alternatively, had the tasks been reassigned to FSE 3, the assignment indicators 930-950 would be moved to the row for FSE 3. Since FSE 3 is not available on Friday, the assignment indicator 940 would be presented in the FSE 3/Monday location. Thus, based on the availability of FSE 3 being different from the availability of FSE 1, the reassignment of the group tasks from FSE 1 to FSE 3 causes the time period of at least one of the reassigned tasks to differ from the originally assigned time periods. Furthermore, the grouping module 240 selects the time periods of the reassigned tasks based on the duration of the original tasks, the user-indicated time period for the first reassigned task, the availability of the resource to which the tasks are reassigned, other tasks assigned to the resource to which the tasks are reassigned, or any suitable combination thereof.

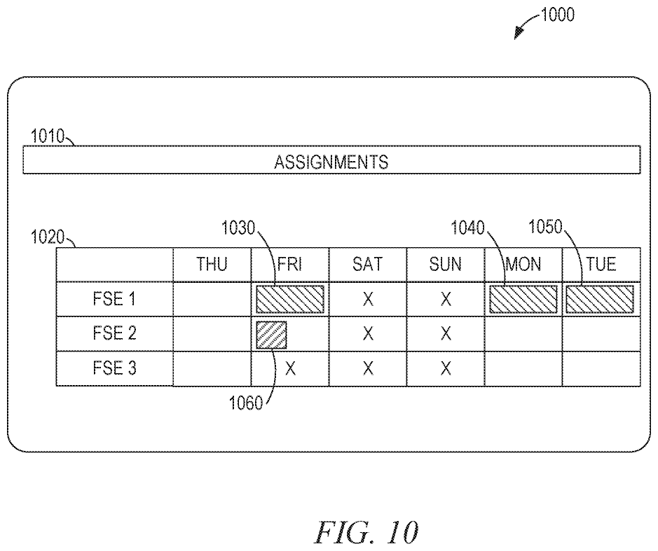

FIG. 10 is a user interface diagram of a user interface 1000 suitable for presenting and modifying group assignments, according to some example embodiments. The user interface 1000 includes a title 1010, an assignment calendar 1020, and assignment indicators 1030, 1040, 1050, and 1060. The user interface 1000 may be displayed after a user input is received via the user interface 700, the user input indicating that the task assigned to FSE 1 on Thursday should be reassigned to the same resource on Friday. For example, the user may have selected the assignment indicator 730 and then selected empty space within the region of the calendar 720 for FSE 1 on Friday. As another example, the user may have dragged the assignment indicator 730 into the region of the calendar 720 for FSE 1 on Friday.

The title 1010 indicates that the user interface 1000 is displaying assignments. The assignment calendar 1020 shows availability and assignments for three resources (FSE 1, FSE 2, and FSE 3) for six days (Thursday-Tuesday).

The assignment indicators 1030, 1040, 1050, and 1060 correspond to the assignment indicators 730, 740, 750, and 760 of FIG. 7. The tasks corresponding to the assignment indicators 730-750 remain assigned to FSE 1, but now are assigned on Friday, Monday, and Tuesday instead of Thursday, Friday, and Monday.

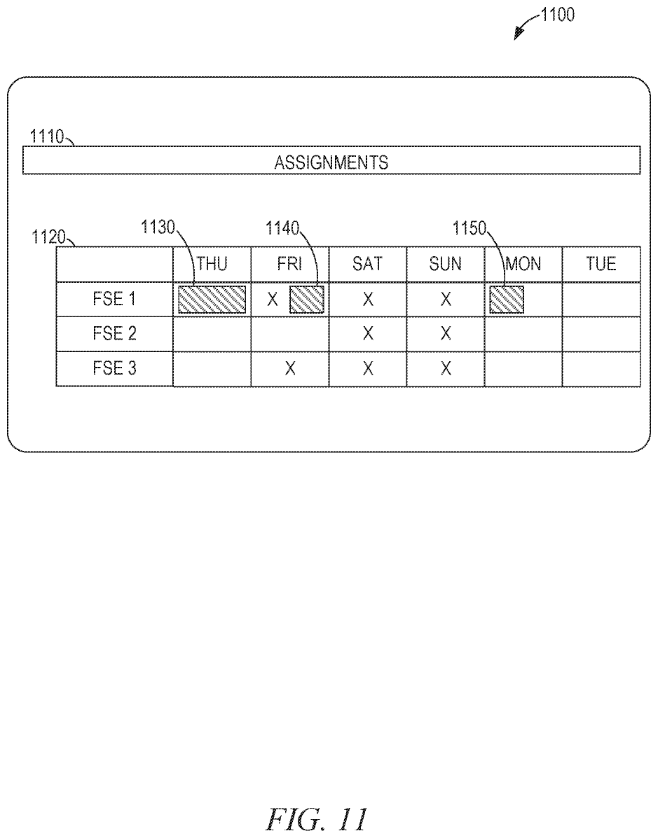

FIG. 11 is a user interface diagram of a user interface 1100 suitable for presenting and modifying group assignments, according to some example embodiments. The user interface 1100 includes a title 1110, an assignment calendar 1120, and assignment indicators 1130, 1140, and 1150.

The title 1110 indicates that the user interface 1100 is displaying assignments. The assignment calendar 1120 shows availability and assignments for three resources (FSE 1, FSE 2, and FSE 3) for six days (Thursday-Tuesday). FSE 2 is available on Thursday, Friday, Monday, and Tuesday. FSE 3 is available on Thursday, Monday, and Tuesday. Each of the three resources is unavailable on Saturday and Sunday, as indicated by the presence of an X for those resource/day combinations. FSE 3 is also unavailable on Friday and FSE 1 is unavailable during the first half of Friday, as indicated by an X set in the left half of the area for FSE 1 on Friday.

In FIG. 11, the assignment indicators 1130, 1140, and 1150 have the same fill pattern. Thus, at a glance, a user can determine that the tasks for the assignments indicated by the assignment indicators 1130-1150 are related to each other. Additionally, positioning of the assignment indicators 1130-1150 within the calendar 1120 indicates at a glance that tasks corresponding to the assignment indicators are assigned to FSE 1 on Thursday, Friday, and Monday. The smaller size of the assignment indicators 1140 and 1150 relative to the size of the assignment indicator 1130 may indicate that the task corresponding to the assignment indicator 1130 is of longer duration than the other tasks. The positioning of each assignment indicator within its calendar area may indicate the time that the corresponding task is to be performed. For example, the task corresponding to the assignment indicator 1130 may be a full-day task, as indicated by the assignment indicator 1130 occupying nearly all of its calendar area. By contrast, the task corresponding to the assignment indicator 1140 may be scheduled for the second half of Friday, as indicated by the position and size of the assignment indicator 1140. Similarly, the task corresponding to the assignment indicator 1150 may be scheduled for the first half of Monday, as indicated by the position and size of the assignment indicator 1150.

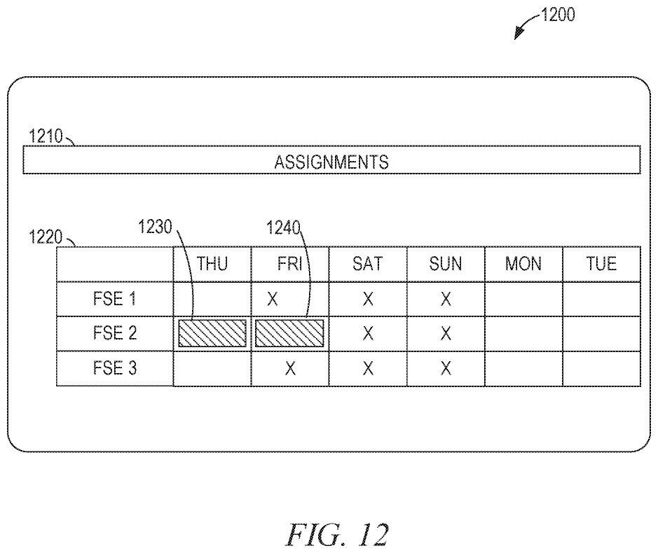

FIG. 12 is a user interface diagram of a user interface 1200 suitable for presenting and modifying group assignments, according to some example embodiments. The user interface 1200 includes a title 1210, an assignment calendar 1220, and assignment indicators 1230 and 1240. The user interface 1200 may be displayed after a user input is received via the user interface 1100, the user input indicating that the task assigned to FSE 1 on Thursday should be reassigned to FSE 2 on the same date. For example, the user may have selected the assignment indicator 1130 and then selected empty space within the region of the calendar 1120 for FSE 2 on Thursday. As another example, the user may have dragged the assignment indicator 1130 into the region of the calendar 1120 for FSE 2 on Thursday.

The title 1210 indicates that the user interface 1200 is displaying assignments. The assignment calendar 1220 shows availability and assignments for three resources (FSE 1, FSE 2, and FSE 3) for six days (Thursday-Tuesday).

The assignment indicator 1230 corresponds to the assignment indicator 1130 of FIG. 11. The assignment indicator 1240 indicates a single task of the same duration as the combined tasks of the assignment indicators 1140 and 1150. By reassigning the grouped assignments from FSE 1 (only available half of Friday) to FSE 2, the grouped assignments are completed on Friday instead of Monday. The combining of the tasks may be handled by the user interface module 220 or the database module 230. If the combining of the tasks is handled by the user interface module 220, the two tasks are maintained as two entries in a database (e.g., in the task table 350) but shown with a single assignment indicator 1040 based on the tasks having the same group identifier and being assigned to the same resource on the same day in an adjacent time period. If the combining of the tasks is handled by the database module 230, the two task entries are combined into a single entry. In some example embodiments, format 355 of the task table 350 includes a duration field that indicates the total duration of the task. In these example embodiments, the duration of the resulting combined entry is the sum of the two original entries.

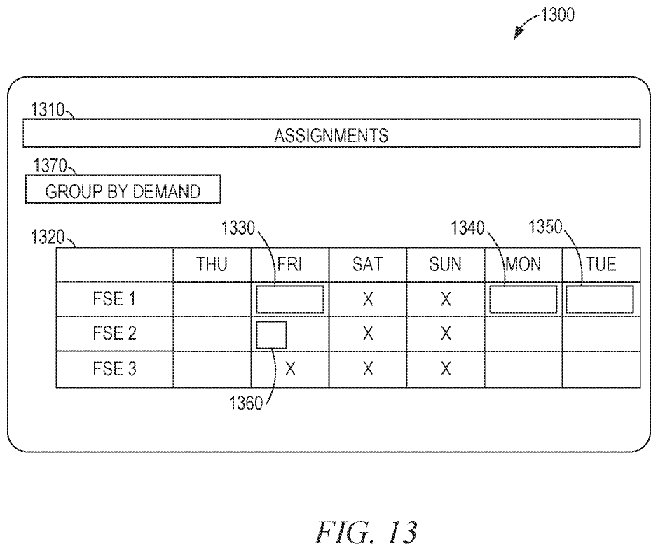

FIG. 13 is a user interface diagram of a user interface 1300 suitable for grouping assignments, according to some example embodiments. The user interface 1300 includes a title 1310, an assignment calendar 1320, assignment indicators 1330, 1340, 1350, and 1360, and a button 1370. The user interface 1300 may be presented before the user interface 700 (FIG. 7).

The title 1310 indicates that the user interface 1300 is displaying assignments. The assignment calendar 1320 shows availability and assignments for three resources (FSE 1, FSE 2, and FSE 3) for six days (Thursday-Tuesday). Unlike the assignment indicators 730-760 of FIG. 7, the assignment indicators 1330-1360 are presented without a fill pattern. This (or another visual attribute) indicates that the tasks corresponding to the assignment indicators 1330-1360 are not grouped. The button 1370, labeled “group by demand,” is operable to cause the grouping module 240 to group assignments for tasks that have the same demand identifier and are assigned to the same resource. Thus, after operation of the button 1370, the user interface 700 may be presented, indicating that the assignments on Thursday, Friday, and Monday for the resource FSE 1 are part of a single group.

In some example embodiments, the grouping is reflected in the database by updating the group identifier value in the rows of the grouped tasks. For example, the rows 360A and 360B (FIG. 3) may be initially created with NULL values for the group identifier and have the group identifier values set to 1 after operation of the button 1370. As a result, since the rows 360A and 360B have the same group identifier after operation of the button 1370, they are recognized as being in a single group by the group assignment module 240.

In other example embodiments, the grouping is reflected only in session memory and is not stored in the database. In these example embodiments, the rows 360A-360C do not store a group identifier.

### EXAMPLES

### Example 1

A method comprising:

causing, by one or more processors, a user interface to be presented on a display device, the user interface including:
an indication of a set of tasks assigned to a first resource for first multiple time periods, each task of the set of tasks corresponding to one of the multiple time periods, the set of tasks comprising a first task corresponding to a first time period of the first multiple time periods and a second task corresponding to a second time period of the first multiple time periods; and
an indication of availability of a second resource;
receiving, via the user interface, a command to reassign the first task from the first resource to the second resource; and
in response to the received command:
reassigning the first task from the first resource to the second resource; and
reassigning the second task from the first resource to the second resource.

### Example 2

The method of example 1, wherein the reassigned first task and the reassigned second task are assigned to the second resource for second multiple time periods, the second multiple time periods being distinct from the first time period and the second time period.

### Example 3

The method of example 2, further comprising:

selecting the first multiple time periods based on availability of the first resource; and
selecting the second multiple time periods based on availability of the second resource;
wherein the second multiple time periods are distinct from the first time period and the second time period based on the availability of the second resource being different than the availability of the first resource.

### Example 4

The method of example 2, wherein:

the command to reassign the first task from the first resource to the second resource comprises an indication of a third time period of the second resource; and
the method further comprises selecting the second multiple time periods based on the third time period.

### Example 5

The method of any of examples 1 to 4, further comprising:

receiving, via the user interface, a second command to group the set of tasks based on each task of the set of tasks being assigned to a single resource.

### Example 6

The method of any of examples 1 to 5, further comprising:

in response to the received command, reassigning a third task of the set of tasks from the first resource to the second resource.

### Example 7

The method of any of examples 1 to 6, further comprising:

updating the user interface to indicate that the first task and the second task are no longer assigned to the first resource.

### Example 8

A system comprising:

a memory that stores instructions; and
one or more processors configured by the instructions to perform operations comprising:
causing a user interface to be presented on a display device, the user interface including:
an indication of a set of tasks assigned to a first resource for first multiple time periods, each task of the set of tasks corresponding to one of the multiple time periods, the set of tasks comprising a first task corresponding to a first time period of the first multiple time periods and a second task corresponding to a second time period of the first multiple time periods; and
an indication of availability of a second resource;
receiving, via the user interface, a command to reassign the first task from the first resource to the second resource; and
in response to the received command:
reassigning the first task from the first resource to the second resource; and
reassigning the second task from the first resource to the second resource.

### Example 9

The system of example 8, wherein the reassigned first task and the reassigned second task are assigned to the second resource for second multiple time periods, the second multiple time periods being distinct from the first time period and the second time period.

### Example 10

The system of example 9, further comprising:

selecting the first multiple time periods based on availability of the first resource; and
selecting the second multiple time periods based on availability of the second resource;
wherein the second multiple time periods are distinct from the first time period and the second time period based on the availability of the second resource being different than the availability of the first resource.

### Example 11

The system of example 9, wherein:

the command to reassign the first task from the first resource to the second resource comprises an indication of a third time period of the second resource; and
the method further comprises selecting the second multiple time periods based on the third time period.

### Example 12

The system of any of examples 8 to 11, further comprising:

receiving, via the user interface, a second command to group the set of tasks based on each task of the set of tasks being assigned to a single resource.

### Example 13

The system of any of examples 8 to 12, further comprising:

in response to the received command, reassigning a third task of the set of tasks from the first resource to the second resource.

### Example 14

The system of any of examples 8 to 13, further comprising:

updating the user interface to indicate that the first task and the second task are no longer assigned to the first resource.

### Example 15

A non-transitory computer-readable medium that stores instructions that, when executed by one or more processors, cause the one or more processors to perform operations comprising:

causing a user interface to be presented on a display device, the user interface including:
an indication of a set of tasks assigned to a first resource for first multiple time periods, each task of the set of tasks corresponding to one of the multiple time periods, the set of tasks comprising a first task corresponding to a first time period of the first multiple time periods and a second task corresponding to a second time period of the first multiple time periods; and
an indication of availability of a second resource;
receiving, via the user interface, a command to reassign the first task from the first resource to the second resource; and
in response to the received command:
reassigning the first task from the first resource to the second resource; and
reassigning the second task from the first resource to the second resource.

### Example 16

The computer-readable medium of example 15, wherein the reassigned first task and the reassigned second task are assigned to the second resource for second multiple time periods, the second multiple time periods being distinct from the first time period and the second time period.

### Example 17

The computer-readable medium of example 16, further comprising:

selecting the first multiple time periods based on availability of the first resource; and
selecting the second multiple time periods based on availability of the second resource;
wherein the second multiple time periods are distinct from the first time period and the second time period based on the availability of the second resource being different than the availability of the first resource.

### Example 18

The computer-readable medium of example 16, wherein:

the command to reassign the first task from the first resource to the second resource comprises an indication of a third time period of the second resource, and
the method further comprises selecting the second multiple time periods based on the third time period.

### Example 19

The computer-readable medium of any of examples 15 to 18, further comprising:

receiving, via the user interface, a second command to group the set of tasks based on each task of the set of tasks being assigned to a single resource.

### Example 20

The computer-readable medium of any of examples 15 to 19, further comprising:

in response to the received command, reassigning a third task of the set of tasks from the first resource to the second resource.

FIG. 14 is a block diagram illustrating components of a machine 1400, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 14 shows a diagrammatic representation of the machine 1400 in the example form of a computer system within which instructions 1424 (e.g., software, a program, an application, an applet, an app, or other executable code) for causing the machine 1400 to perform any one or more of the methodologies discussed herein may be executed, in whole or in part. In alternative embodiments, the machine 1400 operates as a standalone device or may be connected (e.g., networked) to other machines. In a networked deployment, the machine 1400 may operate in the capacity of a server machine or a client machine in a server-client network environment, or as a peer machine in a distributed (e.g., peer-to-peer) network environment. The machine 1400 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1424, sequentially or otherwise, that specify actions to be taken by that machine. Further, while only a single machine is illustrated, the term “machine” shall also be taken to include a collection of machines that individually or jointly execute the instructions 1424 to perform all or part of any one or more of the methodologies discussed herein.

The machine 1400 includes a processor 1402 (e.g., a CPU, a GPU, a digital signal processor (DSP), an application-specific integrated circuit (ASIC), a radio-frequency integrated circuit (RFIC), or any suitable combination thereof), a main memory 1404, and a static memory 1406, which are configured to communicate with each other via a bus 1408. The machine 1400 may further include a graphics display 1410 (e.g., a plasma display panel (PDP), a light-emitting diode (LED) display, a liquid crystal display (LCD), a projector, or a cathode ray tube (CRT)). The machine 1400 may also include an alphanumeric input device 1412 (e.g., a keyboard), a cursor control device 1414 (e.g., a mouse, a touchpad, a trackball, a joystick, a motion sensor, or another pointing instrument), a storage unit 1416, a signal generation device 1418 (e.g., a speaker), and a network interface device 1420.

The storage unit 1416 includes a machine-readable medium 1422 on which are stored the instructions 1424 embodying any one or more of the methodologies or functions described herein. The instructions 1424 may also reside, completely or at least partially, within the main memory 1404, within the processor 1402 (e.g., within the processor's cache memory), or both, during execution thereof by the machine 1400. Accordingly, the main memory 1404 and the processor 1402 may be considered as machine-readable media. The instructions 1424 may be transmitted or received over a network 1426 via the network interface device 1420.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1422 is shown, in an example embodiment, to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., the machine 1400), such that the instructions, when executed by one or more processors of the machine (e.g., the processor 1402), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application programming interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
causing, by one or more processors, a user interface to be presented on a display device, the user interface including:
an indication of a set of tasks assigned to a first resource for first multiple time periods, each task of the set of tasks corresponding to one of the multiple time periods, the set of tasks comprising a first task corresponding to a first time period of the first multiple time periods and a second task corresponding to a second time period of the first multiple time periods; and
an indication of availability of a second resource;
receiving, via the user interface, a command to reassign the first task from the first resource to the second resource; and
in response to the received command:
reassigning the first task from the first resource to the second resource; and
reassigning the second task from the first resource to the second resource.

2. The method of claim 1, wherein the reassigned first task and the reassigned second task are assigned to the second resource for second multiple time periods, the second multiple time periods being distinct from the first time period and the second time period.

3. The method of claim 2, further comprising:
selecting the first multiple time periods based on availability of the first resource; and
selecting the second multiple time periods based on availability of the second resource;
wherein the second multiple time periods are distinct from the first time period and the second time period based on the availability of the second resource being different than the availability of the first resource.

4. The method of claim 2, wherein:
the command to reassign the first task from the first resource to the second resource comprises an indication of a third time period of the second resource; and
the method further comprises selecting the second multiple time periods based on the third time period.

5. The method of claim 1, further comprising:
receiving, via the user interface, a second command to group the set of tasks based on each task of the set of tasks being assigned to a single resource.

6. The method of claim 1, further comprising:
in response to the received command, reassigning a third task of the set of tasks from the first resource to the second resource.

7. The method of claim 1, further comprising:
updating the user interface to indicate that the first task and the second task are no longer assigned to the first resource.

8. A system comprising:
a memory that stores instructions; and
one or more processors configured by the instructions to perform operations comprising:
causing a user interface to be presented on a display device, the user interface including:
an indication of a set of tasks assigned to a first resource for first multiple time periods, each task of the set of tasks corresponding to one of the multiple time periods, the set of tasks comprising a first task corresponding to a first time period of the first multiple time periods and a second task corresponding to a second time period of the first multiple time periods; and
an indication of availability of a second resource;
receiving, via the user interface, a command to reassign the first task from the first resource to the second resource; and
in response to the received command:
reassigning the first task from the first resource to the second resource; and
reassigning the second task from the first resource to the second resource.

9. The system of claim 8, wherein the reassigned first task and the reassigned second task are assigned to the second resource for second multiple time periods, the second multiple time periods being distinct from the first time period and the second time period.

10. The system of claim 9, further comprising:
selecting the first multiple time periods based on availability of the first resource; and
selecting the second multiple time periods based on availability of the second resource;
wherein the second multiple time periods are distinct from the first time period and the second time period based on the availability of the second resource being different than the availability of the first resource.

11. The system of claim 9, wherein:
the command to reassign the first task from the first resource to the second resource comprises an indication of a third time period of the second resource; and
the method further comprises selecting the second multiple time periods based on the third time period.

12. The system of claim 8, further comprising:
receiving, via the user interface, a second command to group the set of tasks based on each task of the set of tasks being assigned to a single resource.

13. The system of claim 8, further comprising:
in response to the received command, reassigning a third task of the set of tasks from the first resource to the second resource.

14. The system of claim 8, further comprising:
updating the user interface to indicate that the first task and the second task are no longer assigned to the first resource.

15. A non-transitory computer-readable medium that stores instructions that, when executed by one or more processors, cause the one or more processors to perform operations comprising:
causing a user interface to be presented on a display device, the user interface including:
an indication of a set of tasks assigned to a first resource for first multiple time periods, each task of the set of tasks corresponding to one of the multiple time periods, the set of tasks comprising a first task corresponding to a first time period of the first multiple time periods and a second task corresponding to a second time period of the first multiple time periods; and
an indication of availability of a second resource;
receiving, via the user interface, a command to reassign the first task from the first resource to the second resource; and
in response to the received command:
reassigning the first task from the first resource to the second resource; and
reassigning the second task from the first resource to the second resource.

16. The computer-readable medium of claim 15, wherein the reassigned first task and the reassigned second task are assigned to the second resource for second multiple time periods, the second multiple time periods being distinct from the first time period and the second time period.

17. The computer-readable medium of claim 16, further comprising:
selecting the first multiple time periods based on availability of the first resource; and
selecting the second multiple time periods based on availability of the second resource;
wherein the second multiple time periods are distinct from the first time period and the second time period based on the availability of the second resource being different than the availability of the first resource.

18. The computer-readable medium of claim 16, wherein:
the command to reassign the first task from the first resource to the second resource comprises an indication of a third time period of the second resource; and
the method further comprises selecting the second multiple time periods based on the third time period.

19. The computer-readable medium of claim 15, further comprising:
receiving, via the user interface, a second command to group the set of tasks based on each task of the set of tasks being assigned to a single resource.

20. The computer-readable medium of claim 15, further comprising:
in response to the received command, reassigning a third task of the set of tasks from the first resource to the second resource.
